(19) United States
(12) Patent Application Publication
(10) Pub. No.: US 2005/0012338 A1
(43) Pub. Date: Jan. 20, 2005

(54) TIDE AND WAVE POWERED GENERATION APPARATUS

(76) Inventor: A-Hsiang Chang, Chia-Yi Hsien (TW)

Correspondence Address: BIRCH STEWART KOLASCH & BIRCH, PO BOX 747, FALLS CHURCH, VA, 22040-0747, US

(21) Appl. No.: 10/617,757

(22) Filed: Jul. 14, 2003

(51) Int. Cl. H02P 9/04; F03B 13/10

(52) U.S. Cl. 290/43

(57) ABSTRACT

A tide and wave powered generation apparatus includes a piping system, a pump station, a low level reservoir, a high level reservoir and a hydraulic turbine generator. The piping system connects the low level reservoir, the pump station, the high level reservoir, the hydraulic turbine generator and the low level reservoir in sequence. The pump station comprises an oil pump engaged with a chain, each end of which is respectively connected with a buoyancy plate and a counter balance weight. When a serial of waves rush to the seashore, the waves surge up and down that makes the buoyancy plate move up and down with the waves. The chain brings the counter balance weight movements in the direction opposite to the buoyancy plate. The movement of the chain drives the pump station to pump water from the low level reservoir to the high level reservoir. Then the water of the high level reservoir is conducted via the piping system to impact onto the blades of the hydraulic turbine generator to generate electricity. The outflow water from the hydraulic turbine generator is conducted via the piping system to the low level reservoir.

### BACKGROUND OF THE INVENTION

1. Field of the Invention

The present invention relates to power generation apparatus, and in particular to a tide and wave powered generation apparatus by using tidal and wave energy to generate electricity.

2. The Related Art

A conventional hydroelectric power generation is to build hydraulic facilities for example dam, weir and channel, and then conduct the water stored in the hydraulic facilities to impact onto the blades of a hydraulic turbine generator to make the blades rotate and thus generate electricity. However this way of power generation causes an adverse effect on rivers and the surrounding animal and plant ecologies thereof. Furthermore, its construction cost is expensive. The service period of the conventional hydroelectric power generation is limited due to silt built up. If lack of careful maintenance, the service period will be further shorted. In addition, the hydraulic facilities are also possibly damaged due to earthquake or other artificial factors. That will cause a great loss of the life and property to the downstream people.

### SUMMARY OF THE INVENTION

In view of the defects of the conventional hydroelectric power generation, an object of the present invention is to provide one way of power generation, which is a tide and wave powered generation apparatus. The tidal and waved energy is used for pumping water from a low level to a high level. Then the high level water is conducted to impact onto the blades of a hydraulic turbine generator to make the blades rotate and thus generate electricity.

To achieve the above object, the apparatus of the present invention comprises a piping system, a pump station, a low level reservoir, a high level reservoir and a hydraulic turbine generator. The piping system connects the low level reservoir, the pump station, the high level reservoir, the hydraulic turbine generator and the low level reservoir in sequence. The pump station comprises an oil pump engaged with a chain, each end of which is respectively connected with a buoyancy plate and a counter balance weight. When a serial of waves rush to the seashore, the waves surge up and down, which makes the buoyancy plate move up and down with the waves. The chain brings up movements of the counter balance weight in the direction opposite to the buoyancy plate. The movement of the chain drives the pump station to pump water from the low level reservoir to the high level reservoir. Then the water of the high level reservoir is conducted via the piping system to impact onto the blades of the hydraulic turbine generator to generate electricity. The outflow water from the hydraulic turbine generator is conducted via the piping system to the low level reservoir.

The present invention has the following advantageous features:

(1) The construction cost is lower than that of hydroelectric power generation. And its impact on the environmental ecologies is also reduced as compared with the conventional hydroelectric power generation.

(2) The present invention make use only of the tidal and waved energy, rather than energy of any other kinds, to provide the motive power for pumping water from a low level reservoir to a high level reservoir.

### BRIEF DESCRIPTION OF THE DRAWINGS

FIG. 1 shows a schematic system diagram of power generation apparatus in accordance with a preferred embodiment of the present invention; and

FIG. 2 shows a schematic system diagram of power generation apparatus in accordance with another embodiment of the present invention.

### DETAILED DESCRIPTION OF THE PREFERRED EMBODIMENT

The configurations, advantageous features and effectiveness of the present invention will be apparent to those skilled in the art after reading the detailed description of the preferred embodiments thereof in reference to the accompanying drawings

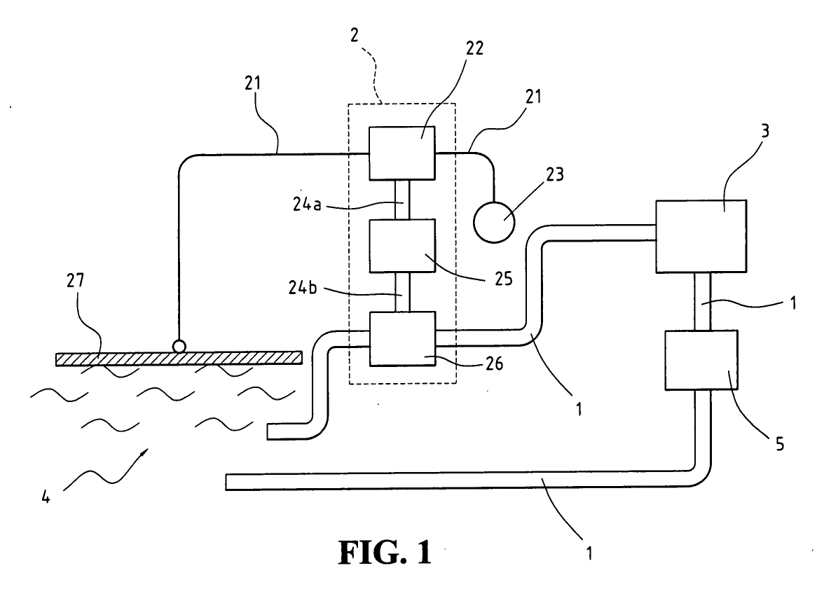

Referring to FIG. 1, power generation apparatus in accordance with the present invention comprises a piping system 1, a pump station 2, a low level reservoir 4, a high level reservoir 3 and a hydraulic turbine generator 5. The piping system 1 connects the low level reservoir 4, the pump station 2, the high level reservoir 3, the hydraulic turbine generator 5 and the low level reservoir 4 in sequence. The pump station 2 comprises an oil pump 22 engaged with a chain 21, each end of which is respectively connected with a buoyancy plate 27 and a counter balance weight 23. The oil pump 22 is coupled to a flywheel and a gearbox 25 associated with the flywheel via a transmission shaft 24a. The flywheel and the gearbox 25 are connected to a pressurizing pump 26 via a transmission shaft 24b. The buoyancy plate 27, the chain 21, the counter balance weight 23 and the pump station 2 are constructed as a motive power of delivering water from the low level reservoir 4 to the high level reservoir 3.

When a serial of waves rush to the seashore, the waves surge up and down, which makes the buoyancy plate 27 move up and down with the waves and as a consequence thereof, the chain 21 brings up movements of the counter balance weight 23 in the direction opposite to the buoyancy plate 27. The movement of the chain 21 actuates the oil pump 22. The oil pump 22 makes the flywheel and the gearbox 25 rotate via the transmission shaft 24a. The flywheel and the gearbox 25 drive the pressurizing pump 26 via the transmission shaft 24b to pump water from the low level reservoir 4 to the high level reservoir 3. The water in the high level reservoir 3 is conducted via the piping system 1 to impact onto the blades of the hydraulic turbine generator 5 to generate electricity. The outflow water from the hydraulic turbine generator 5 is conducted via the piping system 1 to the low level reservoir 4. The low level reservoir 4 is, for example, the sea.

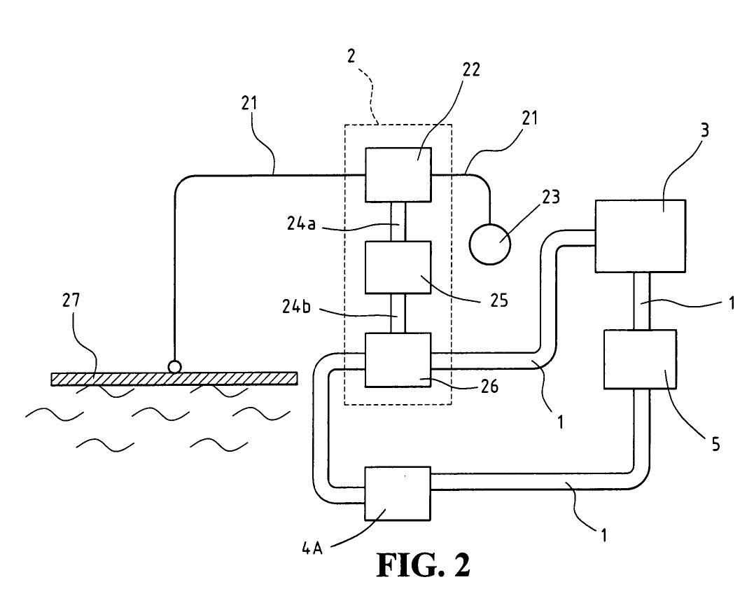

Referring to FIG. 2, power generation apparatus in accordance with another embodiment of the present invention comprises a piping system 1, a pump station 2, a low level reservoir 4A, a high level reservoir 3 and a hydraulic turbine generator 5. The piping system 1 connects the low level reservoir 4A, the pump station 2, the high level reservoir 3, the hydraulic turbine generator 5 and the low level reservoir 4A in sequence. Basically, the construction of this embodiment is substantially identical to that of the previous embodiment shown in FIG. 1. The difference is that the low level reservoir 4 shown in FIG. 1 is the sea but the low level reservoir 4A of the present embodiment is a separate reservoir from the sea. The water of the low level reservoir 4A is not seawater but city water, river water or other water. This prevents the piping system 1 and other facilities from seawater corrosion.

The above statements are only for illustrating the preferred embodiments of the present invention, and not for giving any limitation to the scope of the present invention. It will be apparent to those skilled in this art that all equivalent modifications and changes shall fall within the scope of the appended claims and are intended to form part of this invention.

1. A tide and wave powered generation apparatus comprising a piping system, a pump station, a low level reservoir, a high level reservoir and a hydraulic turbine generator, wherein the piping system connects the low level reservoir, the pump station, the high level reservoir, the hydraulic turbine generator and the low level reservoir in sequence; the pump station comprises an oil pump engaged with a chain, each end of which is respectively connected with a buoyancy plate and a counter balance weight; the oil pump is coupled to a flywheel and a gearbox associated therewith via a first transmission shaft; the flywheel and the gearbox are associated with a pressurizing pump via a second transmission shaft; and the buoyancy plate, the chain, the counter balance weight and the pump station are constructed as a motive power of delivering water from the low level reservoir to the high level reservoir.

2. The tide and wave powered generation apparatus as claimed in claim 1, wherein the low level reservoir is the sea.

3. The tide and wave powered generation apparatus as claimed in claim 1, wherein the low level reservoir is a separate reservoir from the sea.
